(19) United States
(12) Patent Application Publication
(10) Pub. No.: US 2026/0111935 A1
(43) Pub. Date: Apr. 23, 2026

(54) SYSTEM AND METHOD FOR PEER-TO-PEER TRANSACTION VERIFICATION, RATING, AND FRAUD DETECTION

(71) Applicants: Kevin France, Lakewood, CO (US); Matthew Reed, Denver, CO (US); Michael George, Lakewood, CO (US); Andrew Hoyt, Lakewood, CO (US)

(72) Inventors: Kevin France, Lakewood, CO (US); Matthew Reed, Denver, CO (US); Michael George, Lakewood, CO (US); Andrew Hoyt, Lakewood, CO (US)

(21) Appl. No.: 19/360,859

(22) Filed: Oct. 16, 2025

Related U.S. Application Data
(60) Provisional application No. 63/708,730, filed on Oct. 17, 2024.

(51) Int. Cl. G06Q 30/0282; G06Q 20/22; G06Q 20/38; G06Q 20/40

(52) U.S. Cl. CPC G06Q 30/0282; G06Q 20/223; G06Q 20/383; G06Q 20/4016; G06Q 2220/00

(57) ABSTRACT

A system and method for verifying peer-to-peer transactions, rating users, detecting fraud, and preserving privacy across digital and offline environments. The invention enables two-way rating confirmation, optional proof submission in disputes, and an artificial-intelligence, machine-learning-based anomaly-detection module that allocates audits through a bounded-cost control function. Events are scored from behavioral, graph, and content features to identify anomalies and selectively verify transactions. Suspicious activity may be quarantined until verified to maintain score integrity. User credibility scores derive from attributes including timeliness, integrity, and completion, with dynamic normalization that decays older transactions while emphasizing recent verified activity. Scores appear as letter grades or quantitative indicators, with separate buyer and seller indices. Credibility indicators are distributed through web and mobile applications, APIs, and unique public-profile links, allowing verified reputation to follow the user across platforms.

This application claims the benefit of U.S. Provisional Patent Application No. 63/708,730, filed on Oct. 17, 2024, the entirety of which is incorporated herein by reference.

### FIELD OF THE INVENTION

The present invention relates generally to peer-to-peer (P2P) transaction technologies. More particularly, it relates to systems and methods for verifying peer-to-peer transactions, generating or updating user credibility ratings, and/or detecting or mitigating fraudulent behavior across both digital and non-digital environments. The invention is applicable to, but not limited to, integrated digital payment platforms (e.g., Venmo, PayPal, Zelle), online buyer-seller marketplaces (e.g., Craigslist, Reddit Marketplace, Facebook Marketplace), and informal peer-to-peer environments where parties coordinate through social media, messaging applications, or direct communication. It is further applicable to, but not limited to, transactions conducted entirely outside of hosted platforms or payment networks, including in-person exchanges, cash-based transactions, and barter arrangements. The invention enhances trust, transparency, and security by combining mutual transaction verification, objective rating methodologies, and artificial intelligence-based fraud detection.

### BACKGROUND OF THE INVENTION

Peer-to-peer transaction platforms have grown substantially in recent years. Digital payment systems such as Venmo, PayPal, and Zelle, and online marketplaces such as Craigslist, Reddit Marketplace and Facebook Marketplace, have enabled buyers and sellers to exchange funds and goods directly with minimal friction. However, this growth has introduced corresponding challenges in maintaining trust and transparency between transacting parties of which many such parties transact via multiple platforms and through multiple methods, including in-person, cash, or direct exchanges.

Existing solutions for measuring trustworthiness rely heavily on subjective feedback. For example, a five-star review on a marketplace may reflect the user's general satisfaction but does not objectively assess details-including but not limited to such facts as whether the counterparty is who they represent themselves to be, and whether they completed the transaction honestly, on time, and without misrepresentation. Moreover, where available, such rating systems are confined within single platforms. A seller who behaves fraudulently on one platform may continue to transact without consequence on another.

Marketplaces where transactions occur offline or outside the payment rails of the platform present additional vulnerabilities. On Craigslist, for example, two parties may agree to an exchange in person and settle payment through manual cash transfer or a separate payment application. Such transactions typically occur without reliable verification, leaving users exposed to fraud, misrepresentation, and disputes with no objective record. Comparable vulnerabilities arise in offline contexts such as bartering, informal lending, or service-based arrangements coordinated outside of hosted networks, where there is likewise no persistent, objective record of completion.

The lack of a unified credibility framework further compounds these risks. In traditional credit markets, systems such as FICO® and VantageScore® provide standardized measures of creditworthiness across institutions. Few or no standardized mechanisms currently exist for peer-to-peer exchanges, where user behavior may vary significantly across platforms. Consequently, buyers and sellers lack consistent, objective tools for evaluating the trustworthiness of potential counterparties.

There is therefore a need for a cross-platform system that provides objective credibility scores for peer-to-peer participants, verifies identities and transactions with ability to preserve aliases, regardless of the platform or payment method, and detects fraudulent activity in real time, including in environments that operate outside of hosted networks such as in-person cash transactions, barter arrangements, service-based exchanges, and decentralized ecosystems such as blockchain or tokenized networks.

### SUMMARY OF THE INVENTION

Embodiments of the present invention address the limitations of existing systems by providing a system and method for generating, maintaining, and distributing near real-time credibility scores for buyers and sellers in peer-to-peer transactions. The system improves transparency and security by incorporating identity confirmation, transaction verification, fraud detection, and a standardized rating framework that operates across digital, mobile, offline, decentralized, and hybrid transaction environments.

Embodiments of the present invention further extend to environments in which two or more parties engage in transactions without an institutional intermediary, including barter exchanges, service arrangements, and decentralized ecosystems such as blockchain-based or tokenized transactions.

In some embodiments, the invention may be implemented through mobile applications operating on major platforms such as iOS and Android, a centralized web-based portal accessible through any internet browser, a web application that operates on multiple devices (computer, mobile device, tablet) or a combination thereof. In other embodiments, the invention may be distributed through application programming interface (API) connections, embedded code, or other system-integration technologies, enabling interoperability with external platforms. Embodiments of the present invention thus provide a scalable, cross-platform credibility framework for participants in peer-to-peer commerce that follows the user no matter where they transact. In certain embodiments, the system further incorporates a privacy-preserving alias mechanism that enables encrypted two-party confirmations to be decrypted and revealed only after both parties have submitted their inputs, thereby mitigating retaliatory bias and preserving anonymity while maintaining accountability.

In certain embodiments, the system employs or may require two-way rating confirmation. Both buyer and seller are provided an opportunity to verify that a transaction has occurred before ratings are applied, preventing one-sided or fabricated reviews. In other embodiments, the system permits parties to submit transaction proof, such as receipts, payment records, or shipping confirmations, particularly when disputes arise. Such submissions may be processed automatically including, but not limited to, optical character recognition, API-based data transfer, biometric validation, GPS-based co-location, near-field communication (NFC) logs, blockchain-based verification hashes, or any other suitable verification mechanism.

The features described herein may be implemented individually or in any operative combination, with alternative data sources, algorithms, cryptographic techniques, or communication protocols substituted without departing from the spirit or scope of the invention.

Some embodiments of the present invention further include an artificial-intelligence and machine-learning component configured to continuously monitor on-platform user behavior through anomaly detection and budgeted audit selection. The system may detect anomalous rating activity using statistical, heuristic, or learning-based models operating on multi-modal behavioral, relational, and content features, including, but not limited to, repeated negative scores from a single account, unusually rapid submissions, or inconsistent transaction patterns. In some embodiments, the anomaly-detection framework further incorporates graph-based relationship analysis, rule-based constraints, or hybrid model ensembles to enhance detection accuracy and reduce false positives.

Credibility scores are based on weighted measures of timeliness, integrity, and transaction completion, amongst other elements. In some embodiments, the system further applies score dynamics including decay of older transactions, regression of inactive scores toward an equilibrium point, and accelerated upward adjustment for recent positive ratings, thereby balancing stability with responsiveness. Other embodiments may incorporate predictive trust scores, tiered trust badges, or visual indicators such as color codes, icons, or dynamic trust levels. Scores may optionally combine internal performance with verified external data sources, such as but not limited to, identity checks and financial credibility metrics. These factors are aggregated and displayed through an easy-to-visualize rating system, including dashboard-style numerical scales, as well as letter grades from A through F, amongst others. Users may also be grouped into discrete trust tiers such as Silver, Gold, and Platinum, or other relevant descriptors, each defined by score thresholds and associated privileges. In one embodiment, each user maintains a separate buyer and seller scores, ensuring accurate representation of their behavior in different roles. An aggregated score may also be provided showing overall trust.

In some embodiments, the system further supports group-based reputation aggregation, wherein multiple verified users may form a group or network whose collective credibility is represented by a composite group score. Each member's individual score contributes to the group's aggregate credibility according to weighting factors such as trust tier, transaction history, or verification confidence. The group score may in turn influence the standing of its members, creating bidirectional propagation that rewards association with reputable participants and discourages association with unreliable ones. This mechanism enables scalable network effects, allowing reputation to extend beyond individual interactions to collective trust ecosystems.

The system is designed for, including but not limited to, distribution across web-based and mobile applications, a web-based portal, and API-based integrations. In one embodiment, users are assigned unique profile handles and respective URLs that function similarly to networking profiles such as LinkedIn and X.com, allowing profiles and related scores to be accessed outside the system and to be provided to others for verification with a simple URL link or unique handle. In another embodiment, linked external accounts enable automated data import from payment platforms and online marketplaces.

By combining multi-factor verification, objective credibility scoring, AI-based fraud detection and response, and cross-platform distribution, the invention establishes a scalable and reliable framework for trustworthy peer-to-peer commerce.

Embodiments of the present invention also encompass a closed-loop fraud-control framework that combines anomaly detection with selective auditing, enabling verification resources to be allocated efficiently while maintaining model accuracy through continual feedback from verified outcomes.

The embodiments described herein are illustrative and not limiting. Various modifications, substitutions, and alterations can be made without departing from the scope of the invention. For example, while specific transaction environments, verification methods, scoring indicators, or fraud detection techniques have been described, other environments, methods, indicators, and techniques may be employed. Accordingly, the invention extends to all embodiments encompassed by the appended claims and their legal equivalents.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE ACCOMPANYING GRAPHICS

The accompanying concept drawings and graphics, which are incorporated in and constitute a part of the specification, illustrate embodiments of the invention and together with the general description of the invention given above and the detailed description of the drawings given below, serve to explain the principles of these inventions.

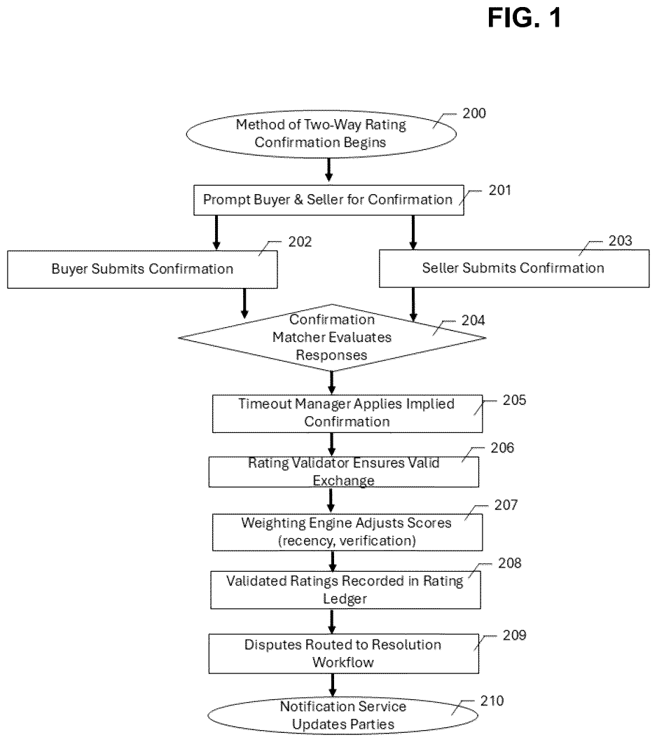

FIG. 1 is a flowchart illustrating a method for user registration and profile creation.

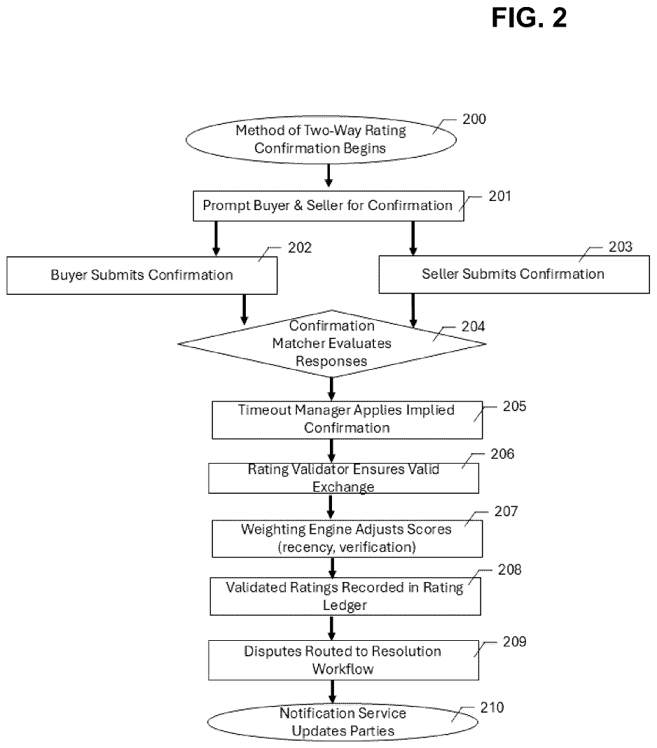

FIG. 2 is a flowchart illustrating a method for two-way rating confirmation.

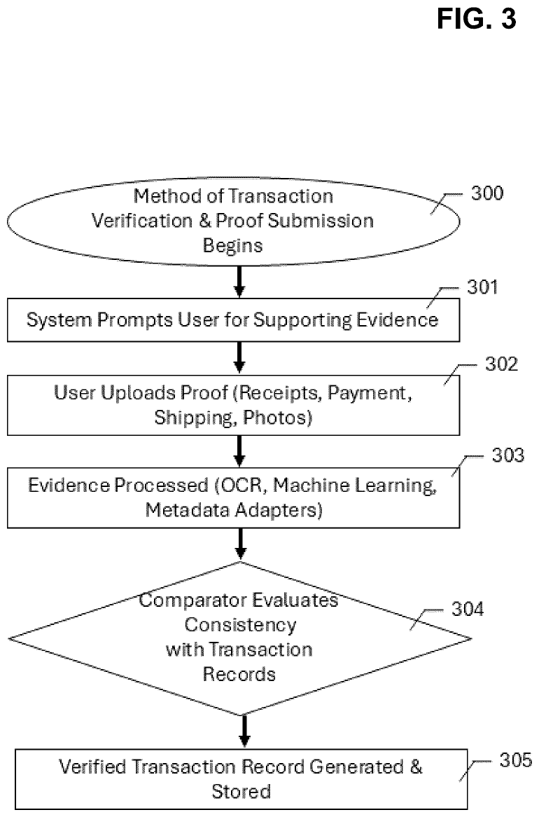

FIG. 3 is a flowchart illustrating a method of transaction verification and proof submission.

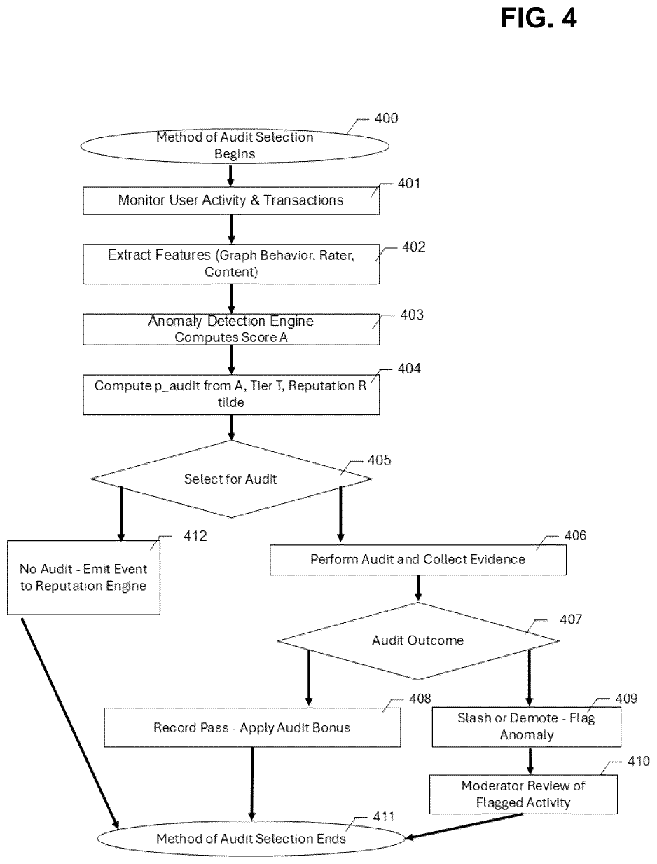

FIG. 4 is a flowchart illustrating a method of anomaly detection and budgeted audit selection in a peer-to-peer credibility system.

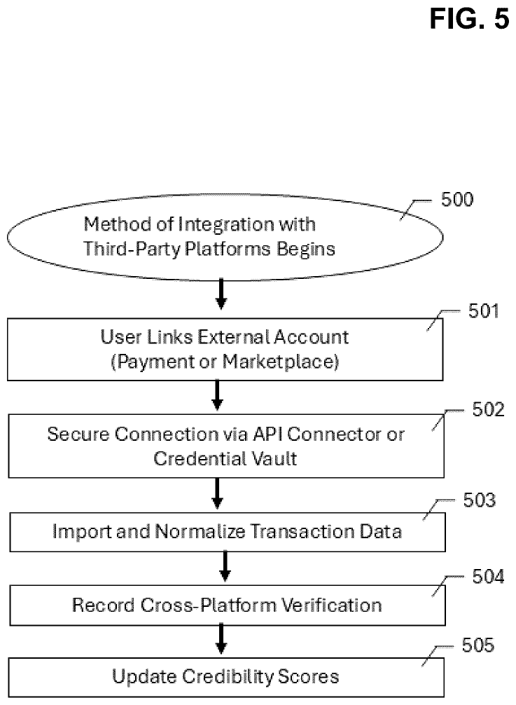

FIG. 5 is a flowchart illustrating a method for integration with third-party platforms.

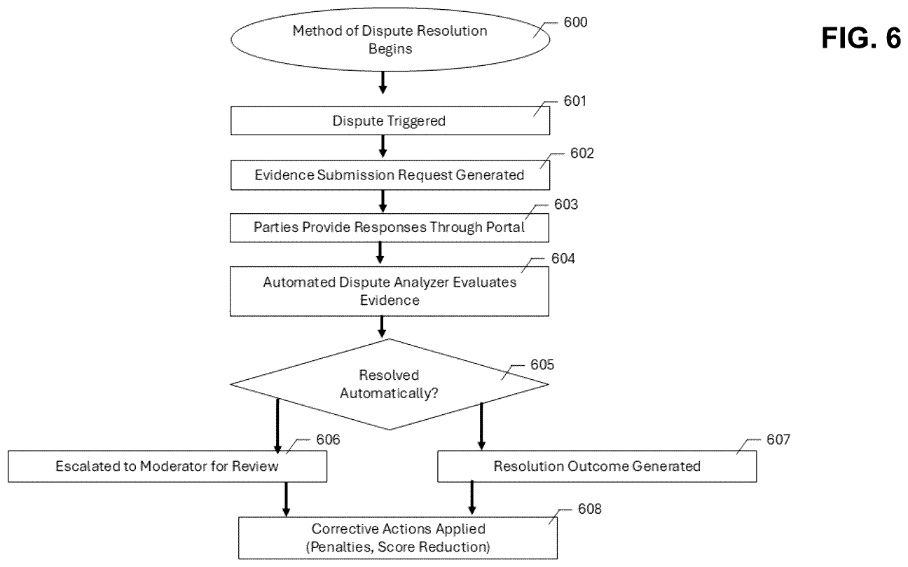

FIG. 6 is a flowchart illustrating a method for dispute resolution.

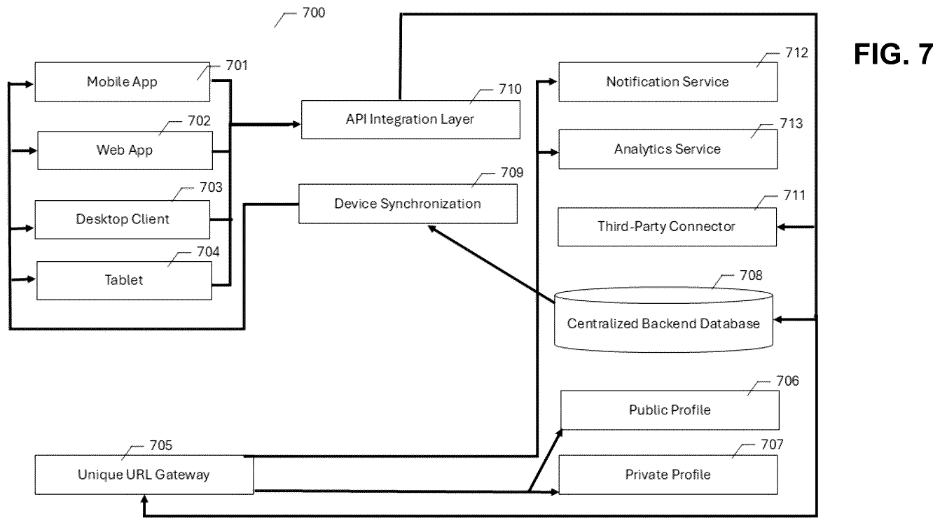

FIG. 7 is a hybrid diagram illustrating cross-platform distribution and integration.

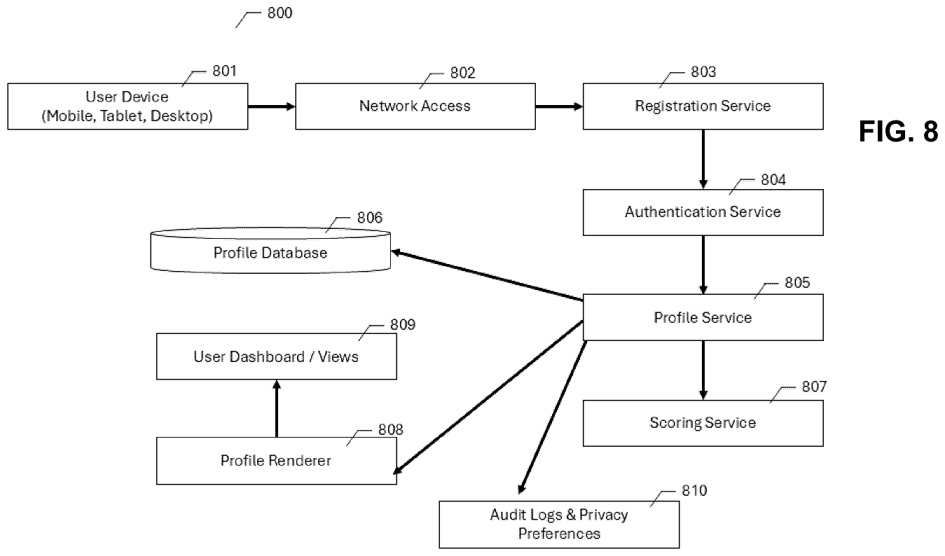

FIG. 8 is a block diagram illustrating a system architecture for registration and profile creation.

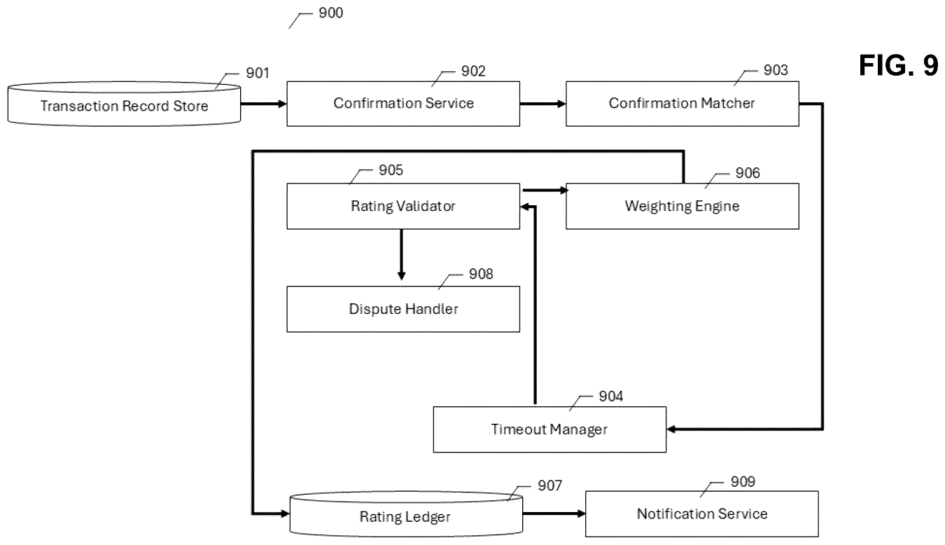

FIG. 9 is a block diagram illustrating a system architecture for rating confirmation.

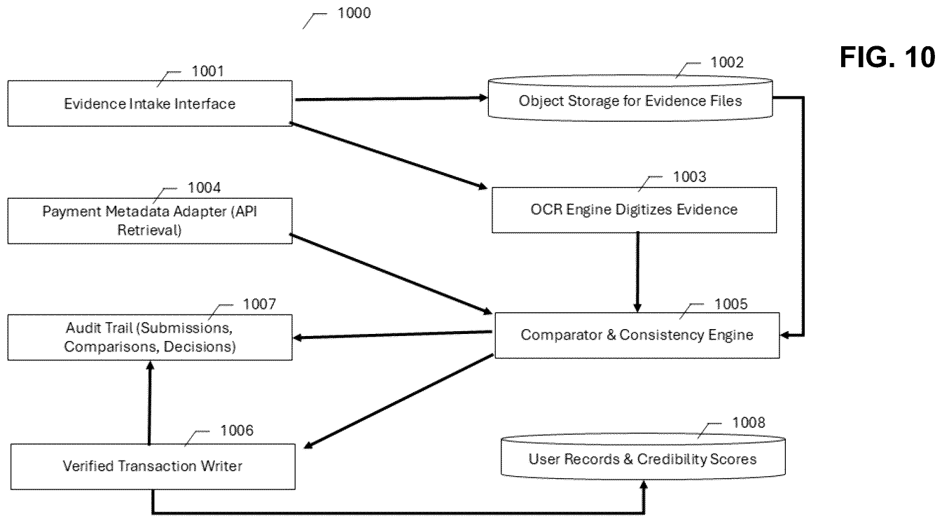

FIG. 10 is a block diagram illustrating a system architecture for proof submission and verification.

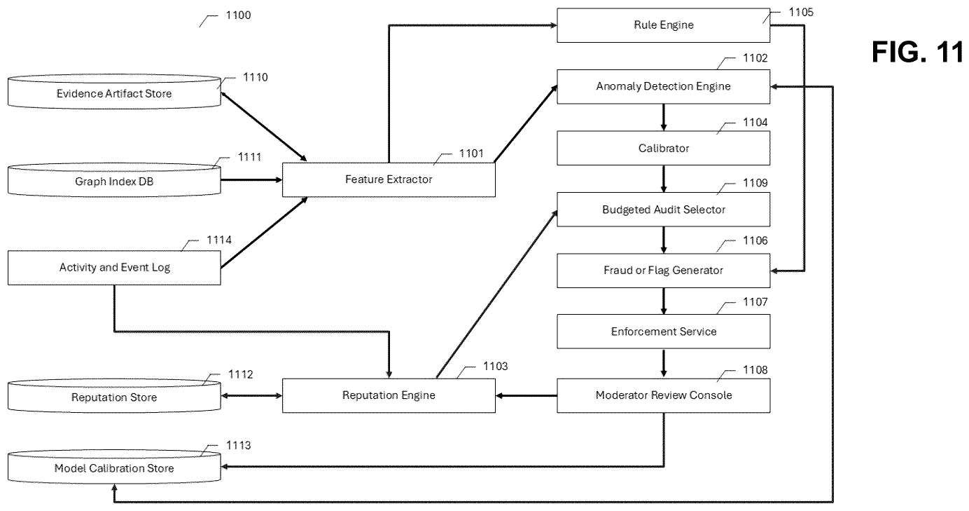

FIG. 11 is a block diagram illustrating the system-level implementation of the audit-selection method outlined in FIG. 4.

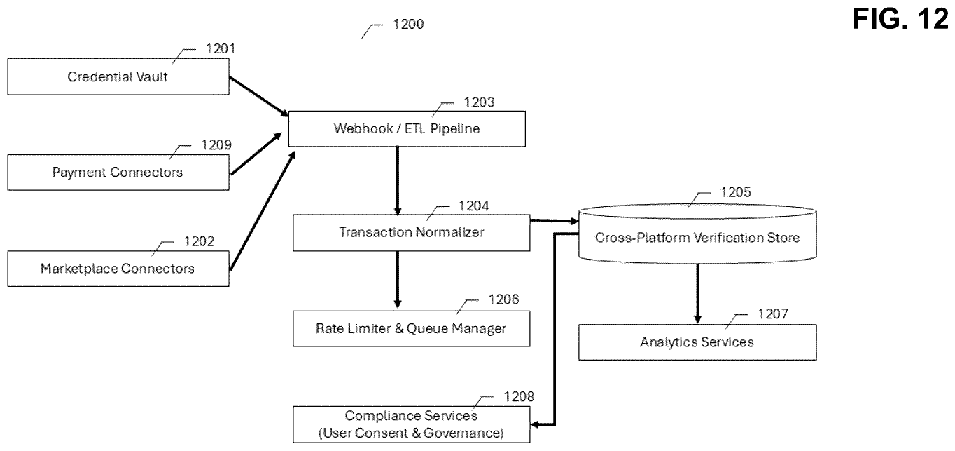

FIG. 12 is a block diagram illustrating an integration layer architecture.

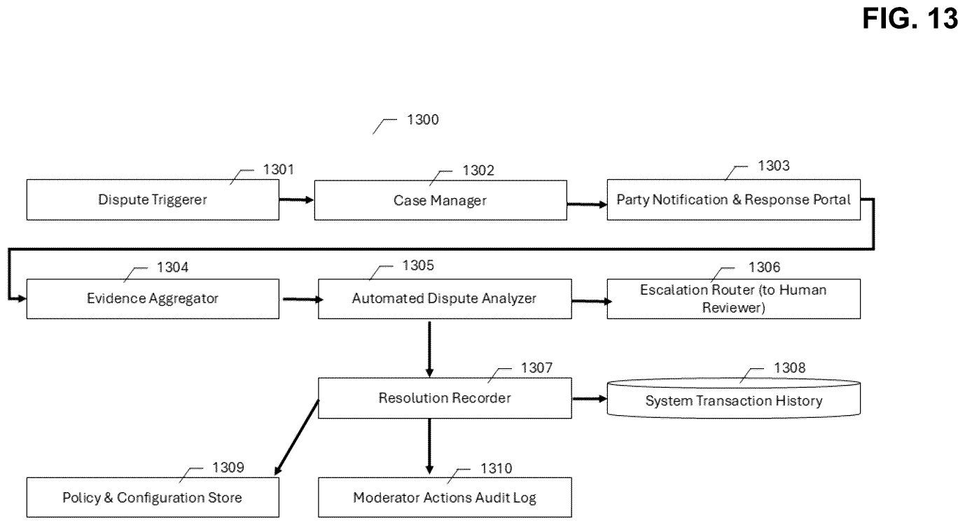

FIG. 13 is a block diagram illustrating a system architecture for dispute resolution.

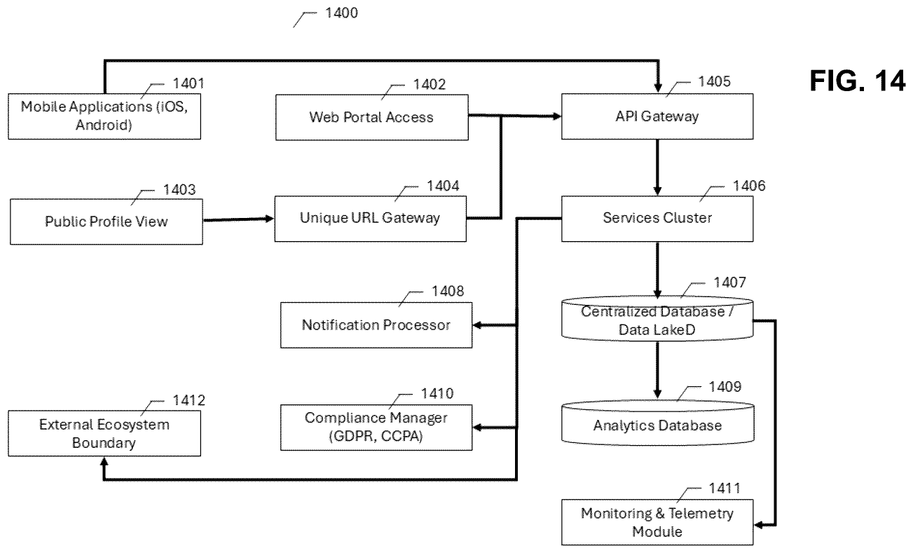

FIG. 14 is a block diagram illustrating a system architecture for cross-platform deployment and distribution.

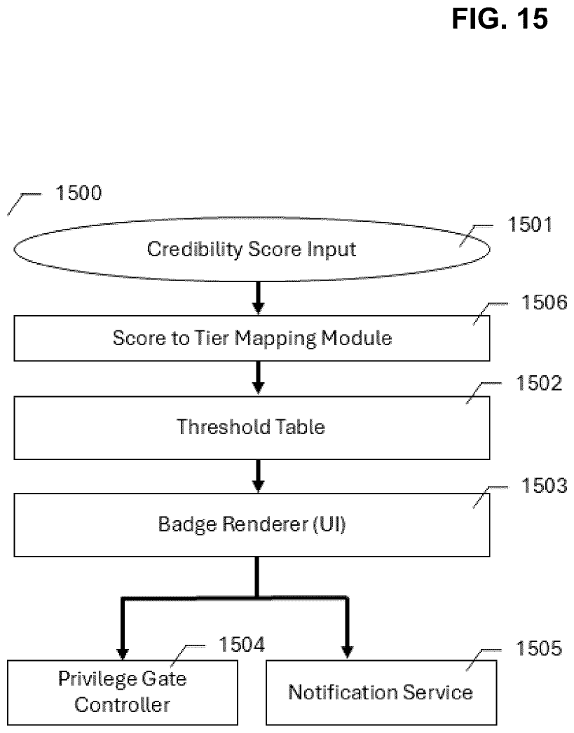

FIG. 15 is a block diagram illustrating a trust-tier and badge-visualization architecture.

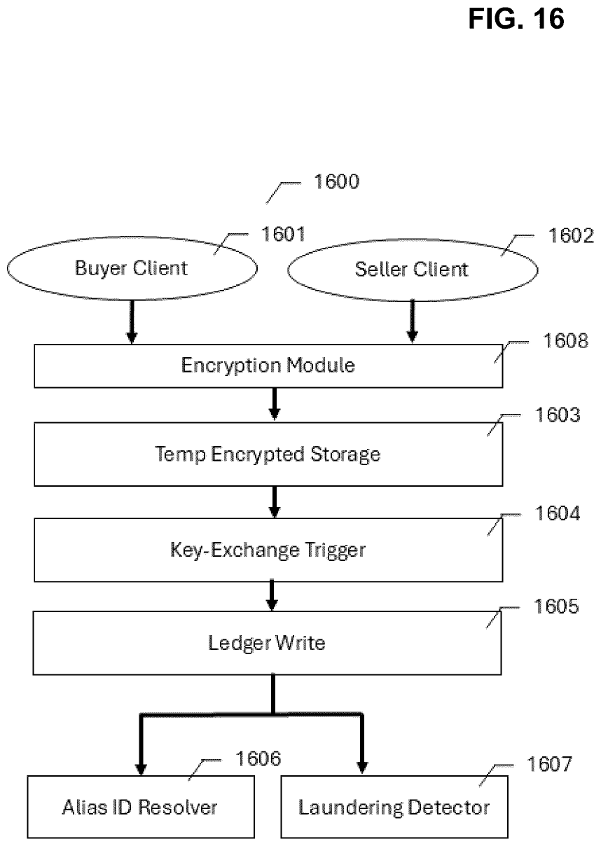

FIG. 16 is a hybrid diagram illustrating a blind-review reveal and alias-privacy flow.

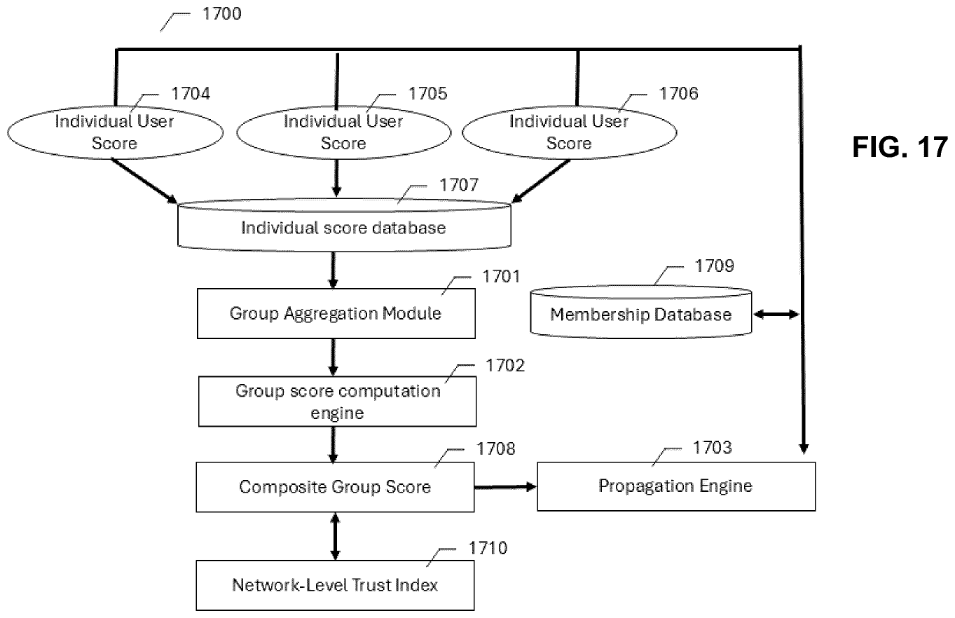

FIG. 17 is a block diagram illustrating a group-based reputation aggregation architecture.

To assist in the understanding of one embodiment of the present invention the following list of components and associated number found in the drawings is provided herein:

| # | Component |
|---|---|
| 100 | Method of Registration |
| 101 | User device (mobile app, web portal, or interface) |
| 102 | Registration input |
| 103 | Input verification module |
| 104 | Multi-factor authentication module |
| 105 | Profile creation module |
| 106 | Buyer credibility score initializer |
| 107 | Seller credibility score initializer |
| 108 | Audit logs and privacy preferences |
| 109 | Profile views (public and private) |
| 200 | Method of Two-Way Confirmation |
| 201 | Rating confirmation prompt |
| 202 | Buyer confirmation |
| 203 | Seller confirmation |
| 204 | Confirmation matcher |
| 205 | Timeout manager (implied confirmation) |
| 206 | Rating validator |
| 207 | Weighting engine |
| 208 | Rating ledger |
| 209 | Dispute Resolution Workflow |
| 210 | Notification Service |
| 300 | Transaction and Verification |
| 301 | Evidence submission request |
| 302 | Proof upload (receipts, payment, shipping, photos) |
| 303 | Evidence processing (OCR, ML, metadata adapters) |
| 304 | Comparator |
| 305 | Verified transaction record |
| 400 | Anomaly detection and Budgeted Audit Selection |
| 401 | Monitor user activity and transactions. |
| 402 | Extract multi-modal behavioral, graph, and content |
| | features. |
| 403 | AI/ML anomaly-detection engine generating score A |
| 404 | Compute audit-selection probability from A, T, \dot{R} |
| 405 | Decision node for audit selection |
| 406 | Perform audit and collect evidence |
| 407 | Evaluate audit outcome |
| 408 | Bonus or vesting reward for passed audits |
| 409 | Slashing or demotion for failed audits |
| 410 | Moderator review of flagged activity |
| 411 | End of audit cycle and model feedback update. |
| 412 | Emit non-audited events to reputation engine |
| 500 | Integration with Third Parties |
| 501 | External account link (payment or marketplace) |
| 502 | API connector / credential vault |
| 503 | Transaction data importer |
| 504 | Cross-platform verification record |
| 505 | Score updater |
| 600 | Dispute Resolution |
| 601 | Dispute trigger |
| 602 | Evidence submission request |
| 603 | Counterparty response portal |
| 604 | Automated dispute analyzer |
| 605 | Automated resolution decision point |
| 606 | Escalation to moderator |
| 607 | Resolution outcome generated |
| 608 | Corrective actions (penalties, voids, score reduction) |
| 700 | Cross-platform Distribution and Client Access |
| 701 | Mobile app |
| 702 | Web app |
| 703 | Desktop client |
| 704 | Tablet |
| 705 | Unique URL assignment |
| 706 | Public profile view |
| 707 | Private profile view |
| 708 | Centralized database |
| 709 | Device synchronization service |
| 710 | API integration layer |
| 711 | Third-party connectors |
| 712 | Notification services |
| 713 | Analytics services |
| 800 | Registration and Profile Creation |
| 801 | User device |
| 802 | Network access |
| 803 | Registration service |
| 804 | Authentication service |
| 805 | Profile service |
| 806 | Profile database |
| 807 | Scoring service |
| 808 | Profile renderer |
| 809 | Dashboard and Views |
| 810 | Audit logs and privacy preferences |
| 900 | Rating Confirmation |
| 901 | Transaction record store |
| 902 | Confirmation service |
| 903 | Confirmation matcher |
| 904 | Timeout manager |
| 905 | Rating validator |
| 906 | Weighting engine |
| 907 | Rating ledger |
| 908 | Dispute handler |
| 909 | Notification service |
| 1000 | Proof Submission and Verification |
| 1001 | Evidence intake interface |
| 1002 | Object storage for evidence |
| 1003 | OCR engine |
| 1004 | Payment metadata adapter |
| 1005 | Comparator engine |
| 1006 | Verified transaction writer |
| 1007 | Audit trail |
| 1008 | User Records & Credibility Scores |
| 1100 | Anomaly Detection and Audit Selection |
| 1101 | Feature extractor |
| 1102 | Anomaly-detection engine |
| 1103 | Reputation engine |
| 1104 | Calibrator/classifier |
| 1105 | Rules engine |
| 1106 | Fraud-flag generator |
| 1107 | Enforcement service |
| 1108 | Moderator review console |
| 1109 | Budgeted audit selector |
| 111 | Evidence artifact store |
| 1111 | Graph index database tracking |
| 1112 | Reputation engine and store |
| 1113 | Model calibration store |
| 1114 | Activity and Event Log |
| 1200 | Integration Layer Architecture |
| 1201 | Credential vault |
| 1202 | Marketplace Connectors |
| 1203 | Webhook / ETL Pipeline |
| 1204 | Transaction Normalizer |
| 1205 | Cross-Platform Verification Store |
| 1206 | Rate Limiter & Queue Manager |
| 1207 | Analytics Services |
| 1208 | Compliance Services |
| 1209 | Payment Connectors |
| 1300 | Dispute Resolution |
| 1301 | Dispute triggerer |
| 1302 | Case manager |
| 1303 | Party notification & response portal |
| 1304 | Evidence aggregator |
| 1305 | Automated dispute analyzer |
| 1306 | Escalation router |
| 1307 | Resolution recorder |
| 1308 | System transaction store |
| 1309 | Policy & configuration store |
| 1310 | Moderator actions audit log |
| 1400 | Deployed System |
| 1401 | Mobile applications |
| 1402 | Web portal access |
| 1403 | Public profiles |
| 1404 | Unique URL gateway |
| 1405 | API gateway |
| 1406 | Services cluster |
| 1407 | Centralized database |
| 1408 | Notification processor |
| 1409 | Analytics database |
| 1410 | Compliance manager |
| 1411 | Monitoring & telemetry module |
| 1412 | External ecosystem boundary |
| 1500 | Trust-tier and Badge-visualization |
| 1501 | Credibility Score Input |
| 1502 | Threshold Table |
| 1503 | Badge Renderer (UI) |
| 1504 | Privilege Gate Controller |
| 1505 | Notification Service |
| 1506 | Score-to-Tier Mapping Module |
| 1600 | Blind-review Reveal and Alias-privacy |
| 1601 | Buyer Client |
| 1602 | Seller Client |
| 1603 | Temporary Encrypted Storage |
| 1604 | Key-Exchange Trigger |
| 1605 | Ledger Write (Decrypted Ratings) |
| 1606 | Alias ID Resolver |
| 1607 | Laundering Detector |
| 1608 | Encryption Module |
| 1700 | Group-Based Reputation Aggregation |
| 1701 | Group Aggregation Module |
| 1702 | Group Score Computation Engine |
| 1703 | Propagation Engine |
| 1704 | Individual User Score |
| 1705 | Individual User Score |
| 1706 | Individual User Score |
| 1707 | Individual Score Database |
| 1708 | Composite Group Score |
| 1709 | Membership Database |
| 1710 | Network-Level Trust Index |

It should be understood that the drawings are not to scale but diagrammatic in nature. In certain instances, details that are not necessary for an understanding of the invention or that render other details difficult to perceive may have been omitted. It should be understood that the invention is not necessarily limited to the particular embodiments illustrated herein.

### DETAILED DESCRIPTION

The following detailed description refers to the accompanying drawings, which form a part hereof, and in which are shown by way of illustration specific embodiments in which the invention may be practiced. These embodiments are described in sufficient detail to enable those skilled in the art to practice the invention, and it will be understood that other embodiments may be utilized and that structural, logical, and procedural changes may be made without departing from the spirit and scope of the invention. The figures illustrate both method flowcharts and system block diagrams to show how the invention may be implemented in practice. Like reference numbers in the drawings refer to like elements throughout.

Referring now to FIG. 1, a method of user registration and profile creation 100 is illustrated. The method begins when a user initiates access to the platform through a computing device such as a mobile application, web portal, or other connected interface 101. The system receives registration input 102, which may include an email address, telephone number, or OAuth-based authentication from a third-party provider. The system verifies the registration input 103 and may further require multi-factor authentication 104, such as an emailed one-time passcode, credential vault confirmation, or biometric check. Upon successful authentication, the platform creates a new user profile 105, initializes a buyer credibility score 106 and a seller credibility score 107, and configures audit logs and privacy preferences 108. In some embodiments, the registration service 803 generates a verified pseudonymous identifier (“alias ID”) cryptographically linked to the user's confirmed identity but displayed without personally identifying information. Transactions reference this alias ID, ensuring accountability while preserving privacy. In some embodiments, alias identifiers may be periodically regenerated or cryptographically salted with device-specific entropy to prevent long-term linkage while preserving the continuity of verified reputation data. The system then generates both a public-facing profile and a private, logged-in profile view 109.

Referring now to FIG. 2, a method of two-way rating confirmation 200 is illustrated. After a transaction is recorded, the system prompts both the buyer and the seller to provide confirmation 201. The buyer submits a confirmation 202, and the seller submits a corresponding confirmation 203 (or vice-versa). A confirmation matcher 204 evaluates whether both responses align. If one party fails to respond within a defined time, a timeout manager 205 may treat the absence as implied confirmation. In some embodiments, rating submissions or confirmation outcomes may be released in synchronized batches or after a temporal offset to prevent retaliatory or punitive scoring behavior, ensuring decorrelation between counterparties' rating disclosures. A rating validator 206 ensures that a valid exchange occurred before passing the result forward.

In some embodiments, buyer and seller confirmations are encrypted and held in temporary storage until both submissions occur. When the second confirmation is received, the system performs a key-exchange reveal so that both ratings are decrypted and published simultaneously. This blind-reveal mechanism prevents retaliatory or biased reviews and is depicted in FIG. 16.

In some embodiments, a weighting engine 207 is applied to adjust the credibility impact of ratings.

Ratings may be weighted more heavily if the underlying transaction was verified through external data sources or if it occurred recently, while older ratings may decay in influence over time. In some embodiments, the scoring service further incorporates a normalization function that biases user scores toward an equilibrium value across the platform. When a user remains inactive for a period of time, their credibility score gradually regresses toward the average, preventing stale scores from overstating credibility. Conversely, when new positive transactions occur, the system applies an asymmetric weighting that accelerates upward score adjustments relative to downward decay, enabling recent trustworthy activity to improve scores more rapidly than inactivity diminishes them. This dual mechanism of regression and asymmetric rebound ensures that scores remain both current and responsive to recent behavior.

In one embodiment, a user's credibility score is updated dynamically through a two-part process comprising an event-driven adjustment and a time-based normalization. The event-driven adjustment modifies the score in response to new user activity, such as a transaction review. This adjustment is a calculated delta, ΔS, applied to the current score. The value of this delta is determined by the product of three terms:

$$Δ S = α \cdot wb \cdot vr$$

Where:
vr represents the intrinsic value of a review, normalized to a continuous scale (e.g., −1.0 to +1.0).
wb is a computed believability weight for the review, ranging from 0 to 1. This weight is a function of trust-related signals, such as the reviewer's identity verification status, their historical credibility, and an attenuation factor applied specifically to anonymous reviews.
α is a global impact parameter that scales the overall sensitivity of the score to individual events.

The time-based normalization is a function applied periodically to regress the score, toward a predetermined equilibrium value, Seq which may represent the platform-wide average score. This acts as a stabilizing mechanism, ensuring scores of inactive users trend toward a baseline. This regression can be modeled in several ways:
Linear Model: The score is adjusted by an amount directly proportional to its distance from the equilibrium. The change in score per time step can be expressed as ΔS=λ(S_{eq}−S), where λ is a rate constant. This constant can be different for scores above versus below the equilibrium point.
Exponential Model: The score moves toward the equilibrium by reducing the difference between the score and the equilibrium by a fixed percentage with each time step. The score at the next time step, Sₜ₊₁, is given by the recurrence relation Sₜ₊₁=S_{eq}+(Sₜ−S_{eq})(1−k), where k is the decay rate (a value between 0 and 1). Validated ratings are recorded in a rating ledger 208, and unresolved disputes are routed to dispute resolution workflows 209 as shown in FIG. 6. A notification service 210 communicates updated scores to both parties, ensuring transparency of credibility updates.

In some embodiments, verification tiers (e.g., direct API-sourced transaction records, OCR-processed receipts, or manually uploaded evidence) are assigned reliability weights. These weights influence the impact of corresponding ratings on the credibility score, with higher-tier verification sources carrying greater weight than lower-tier sources. Verification tiers may be assigned numeric multipliers, e.g., API-sourced records=1.0, OCR-processed receipts=0.75, manual uploads=0.4, thereby producing proportional influence on the composite score.

Alternative implementations may use different timing, encryption, or reveal protocols to accomplish equivalent mutual-confirmation behavior without departing from the principles of the invention.

Referring now to FIG. 3, a method of transaction verification and proof submission 300 is illustrated. When a transaction is flagged as disputed or requires validation, the system prompts a party to provide supporting evidence 301. The party may upload receipts, payment confirmations, photographs, or shipping records 302. Submitted materials may be processed using one or more techniques such as OCR, machine learning, metadata adapters 303, as well as other automated or manual validation tools. In some embodiments, verification may also incorporate biometric authentication, device proximity logs (Bluetooth, NFC), timestamped GPS co-location, or decentralized ledger entries serving as immutable evidence. A comparator 304 evaluates whether the submitted information matches transaction records. If consistent, the system generates a verified transaction record 305.

In one embodiment, transaction attachments serve as structured proof of interactions, extending beyond text-based confirmations. The attachment ingestion pipeline stores such materials for later review, enabling disputes to be adjudicated based on objective data. Verified transaction records may then feed back into dispute resolution (FIG. 6) or fraud detection (FIG. 11), ensuring that credibility scores are updated only on the basis of validated exchanges.

Referring now to FIG. 4, a method 400 for anomaly detection and budgeted audit selection in a peer-to-peer credibility system based on artificial intelligence and machine learning is illustrated. The method begins with monitoring user activity and transactions 401, wherein an event record—including identifiers of the parties, transaction context, rating value, associated text, and any attached evidence—is ingested into the system. A feature extractor 402 derives a multi-modal feature vector representing the behavioral, relational, and content characteristics of the event.

These features may include graph-based interaction attributes computed from a time-decayed bipartite graph of users and counterparties, such as reciprocity, partner concentration, spectral residuals, and cluster-share statistics; behavioral time-series metrics including the rate of scoring events, inter-event intervals, burstiness, and cap utilization; rater-calibration statistics such as dispersion, entropy, and calibration error relative to audited truth; and content-consistency signals derived from embedding-space divergence between claim text and fulfillment evidence, as well as contradiction or template-deviation indicators. The resulting feature vector is processed by an anomaly-detection engine 403, which produces a normalized anomaly score A∈[0, 1] indicating deviation from normative behavior. The system then retrieves the user's tier T and a conservative reputation estimate \tilde{R} and computes an audit-selection probability 404 according to a budgeted control function:

$${p}_{audit} = clip ( {p}_{0} ( T ) \cdot ( 1 + ηA ) \cdot {e}^{- μ \tilde{R}} , {p}_{min} , {p}_{max} )$$

Where:
p₀(T) is a base audit rate determined by trust tier, η is an anomaly-sensitivity factor, μ controls attenuation with reputation, and the clip function enforces global minimum and maximum bounds.

Other monotonic or bounded functions, including linear, logistic, or piece-wise approximations, may likewise be employed to achieve equivalent cost-bounded audit allocation. In alternative embodiments, any cost-bounded control, reinforcement-learning policy, or heuristic scheduling algorithm may be substituted to achieve similar verification-budget allocation. Based on this probability, a decision node 405 determines whether the event is selected for audit. If not, the system emits the event 412 to the reputation engine for normal weighting and score update. If an audit is triggered, the system performs an audit and collects evidence 406 to verify authenticity or fulfillment.

The audit outcome 407 determines subsequent actions: a failed audit results in slashing or demotion 409 and generation of a fraud flag for moderator review 410, while a successful audit leads to recording a pass and application of an audit bonus or vesting reward 408. The method then terminates 411, closing the loop between anomaly detection, selective verification, and continuous model calibration. Over time, audit outcomes update both the anomaly-detector parameters and the user's reputation record, allowing the system to allocate limited verification resources efficiently while maintaining the integrity of the reputation signal. In some embodiments, the system uses outcomes from verified transaction reviews to refine the parameters of the anomaly-detection model, creating a feedback-label loop that continuously improves accuracy and audit allocation efficiency.

This method-level process may be implemented by the system architecture described with respect to FIG. 11, wherein the budgeted-audit selector, calibrator, and model-calibration store provide the persistent mechanisms enabling continuous refinement of the audit-selection model.

Referring now to FIG. 5, a method of integration with third-party platforms 500 is illustrated. A user elects to link an external account such as a payment service or marketplace 501. The system establishes a secure connection through an API connector or credential vault 502 and imports relevant transaction data 503. The data is normalized and recorded as a cross-platform verification record 504, which is then applied to update the user's credibility scores 505. Integrations may be achieved through standardized APIs, proprietary SDKs, decentralized-network adapters, or any equivalent interoperability layer. In some embodiments, privacy-preserving verification may be achieved using zero-knowledge proof protocols, allowing the system to confirm transactional validity or credential ownership without disclosing underlying sensitive data.

Referring now to FIG. 6, a method of dispute resolution 600 is illustrated. A dispute is triggered 601 when a transaction or rating is contested. The system generates an evidence submission request 602 and prompts both parties to provide responses through a counterparty portal 603. An automated dispute analyzer 604 evaluates the submissions and may call the verification process of FIG. 3. If unresolved 605, the case is escalated to a moderator for review 606. In certain embodiments, unresolved disputes are first submitted to a peer-review arbitration panel composed of verified users, as exemplified in FIG. 6 and corresponding to Claim 16. The panel reviews anonymized evidence packets, votes on outcomes, and the aggregated result is recorded in resolution store 1308 before final moderator confirmation. A resolution outcome is generated and recorded in the system 607. Corrective actions 608 may include reducing credibility scores, voiding ratings, or applying penalties. In some embodiments, disputes may also be resolved through automated escrow release, third-party arbitration plug-ins, or integration with external verification authorities that can validate transaction records. Automated escrow release may be conditioned on mutual confirmation or verified proof threshold.

In some embodiments, the methods of FIGS. 1-6 are applied to transactions conducted without a hosted payment network or marketplace. For example, two parties completing a cash or barter exchange may each submit confirmations through the system without reliance on a third-party platform. Optional supplemental verification can include biometric authentication, timestamped GPS co-location, device proximity logs (Bluetooth/NFC), or manual receipt uploads, after which credibility updates are generated for each party based on the verified exchange.

Alternative dispute-resolution frameworks or automated negotiation protocols may be substituted without departing from the invention.

Referring now to FIG. 7, a hybrid diagram illustrating cross-platform distribution and integration 700 is illustrated. The service backend, which may include a web server, database, and source code, is accessible through mobile applications 701, web applications 702, desktop clients 703, tablets 704, or other devices. In other embodiments, the platform may be deployed in decentralized or edge environments, integrated into point-of-sale (POS) hardware, or embedded within smart contracts and payment terminals, amongst others. Each user may be assigned a unique URL 705 enabling public profile access. Profiles may include a public view 706 and a private view 707. A centralized database 708 synchronizes user data across devices 709, while an API integration layer 710 and third-party connectors 711 enable external ecosystem interoperability. Notification services 712 deliver alerts to users, and analytics services 713 collect anonymized usage and fraud metrics. In one embodiment, the analytics services may classify users into defined trust tiers such as Silver, Gold, and Platinum, with each tier corresponding to a range of credibility scores and associated privileges as shown in FIG. 15.

Referring now to FIG. 8, a registration architecture 800 is illustrated. A user device 801 communicates through a network 802 to access the platform. A registration service 803 receives user input, and an authentication service 804 verifies identity through mechanisms such as two-factor authentication. Upon success, a profile service 805 creates a new user profile in a profile database 806. A scoring service 807 initializes buyer and seller credibility scores, or imports prior trust indicators from linked profiles, establishing a baseline reputation state at registration, while audit logs and privacy preferences 810 are stored. In certain embodiments, the scoring service 807 computes credibility scores conditionally on contextual parameters of the transaction, such as category, value, or counterparty role, producing context-specific trust values tailored to the interaction type. A profile renderer 808 generates user dashboards and public views 809. The registration and scoring services may be distributed, cloud-based, or client-hosted, and may employ alternative data schemas or machine-learning models.

Referring now to FIG. 9, a rating confirmation architecture 900 is illustrated. A transaction record store 901 maintains completed transaction data. A confirmation service 902 receives buyer and seller confirmations, which are compared by a confirmation matcher 903. A timeout manager 904 applies implied confirmation if necessary. A rating validator 905 verifies mutual confirmation and applies scoring rules. The rating validator 905 may further compute a confidence coefficient C∈[0, 1] representing the statistical reliability of each credibility score based on the quantity and variance of historical ratings. The coefficient C is stored with the rating ledger 907 and may be read by analytics services to display a ±range around the public score. A weighting engine 906 adjusts scores based on recency or verification tier. Confirmed ratings are written to a rating ledger 907, with disputes routed to a dispute handler 908. A notification service alerts parties of updates. In some embodiments, before submitting a rating, each user may stake a fraction of their credibility value. If the rating is later found fraudulent, the staked amount is proportionally reduced, discouraging misuse and providing automatic accountability. Other incentive or deterrent mechanisms, including escrow deposits or penalty weighting, may be used in equivalent fashion.

Referring now to FIG. 10, a proof-submission and verification architecture 1000 is illustrated. An evidence-intake interface 1001 receives proof submissions. Evidence is stored in object storage 1002 and processed by an OCR engine 1003. A payment-metadata adapter 1004 retrieves structured data from third-party systems. A comparator engine 1005 evaluates consistency, and if confirmed, a verified-transaction writer 1006 updates verified records and emits scoring-update events to a scoring service, which adjusts credibility values accordingly and persists the result to a verified-record store 1008. An audit trail 1007 logs all submissions and decisions. In some embodiments, the verified-transaction writer 1006 also persists a hash of the verified record to a distributed ledger or blockchain to provide an immutable audit anchor.

In some embodiments, finalized verification outcomes are fed back as labeled data to calibrate the anomaly-detection engine described with respect to FIG. 11. The architecture may incorporate alternative AI frameworks, hybrid rule-learning models, or privacy-preserving training methods without departing from these teachings.

Referring now to FIG. 11, which provides the system-level implementation of the audit-selection method outlined in FIG. 4, a multi-modal anomaly-detection and budgeted-audit-selection architecture 1100 based on artificial intelligence and machine learning is illustrated.

An activity and event log 1114 records user transactions, ratings, and disputes in real time. The event data are provided to a feature extractor 1101, which derives multi-modal feature vectors combining graph-based interaction metrics, behavioral time-series indicators, rater-calibration statistics, and content-consistency embeddings. Representative features include reciprocity ratios, transaction velocity, burstiness, calibration error against verified truth, and embedding-space divergence between claim text and fulfillment evidence.

The extracted features are processed by an anomaly-detection engine 1102, which produces an initial anomaly score A indicating deviation from normal behavioral patterns. In some embodiments, the anomaly-detection engine 1102 operates with an anomaly-score calibrator or classifier 1104 to form a calibrated anomaly-detection module that fuses graph-connectivity metrics, behavioral-velocity features, rater-calibration weights, and content-consistency vectors into a monotonic, interpretable anomaly probability. The calibrator 1104 may apply isotonic or supervised calibration to ensure bounded uncertainty and improved decision reliability. This calibrated anomaly-detection module functions within the broader budgeted-audit-selection architecture to allocate verification effort efficiently while maintaining detection precision.

A rule engine 1105 may operate in parallel, performing deterministic or threshold-based evaluations to supplement or override statistical outputs. The resulting data are combined within a fraud- or flag-generator 1106, which assigns severity ratings and confidence levels to potential anomalies. The fraud-flag generator 1106 may detect reputation-laundering behavior by correlating shared payment accounts, devices, or alias identifiers, quarantining affected records in an evidence-artifact store 1110 until verification is complete.

Audit selection is managed by a budgeted audit selector 1109, which integrates the anomaly score A, user trust tier T, and conservative reputation estimate R to compute an audit probability under a budgeted control function. This mechanism ensures that limited verification resources are allocated to the highest-impact or most uncertain events, and maintains the general health of the system via audit stochasticity. When audit data or supporting materials are collected, they are stored in the evidence-artifact store 1110. Metadata and event records from 1110 are exposed via an indexing pipeline consumed by the graph-index database 1111, which updates nodes and edges and maintains provenance pointers (artifact_id, hash, timestamp) back to 1110 for cross-correlation and reputation-laundering detection.

Severity-weighted flags and audit outcomes are transmitted to an enforcement service 1107, which applies corresponding actions such as warnings, restrictions, or suspensions. Items associated with active fraud flags may be placed in a temporary suspense state, delaying updates to the credibility ledger and public-reputation profile until cleared. These suspended records are prioritized by severity for automated or moderator-driven resolution. When human review is required, cases are escalated to a moderator-review console 1108, where moderators evaluate contextual evidence and record final determinations.

Feedback from audit and moderation outcomes is aggregated in a model-calibration store 1113, which supplies continual learning data to the anomaly-detection engine 1102 and the calibrator 1104. Updated weights and thresholds are propagated to improve detection accuracy and audit allocation over time. Verified-reputation outcomes are managed by the reputation engine 1103, which synchronizes updates with a reputation store 1112 and related components such as vesting or clawback ledgers and promotion gates.

Together, the model-calibration store 1113, reputation engine 1103, and reputation store 1112 maintain system coherence between fraud control, user rewards, and trust-tier progression. This closed-loop AI/ML architecture integrates detection, flagging, auditing, enforcement, and feedback calibration to ensure dynamic, evidence-driven governance of user credibility while maintaining bounded audit cost and preserving the integrity of the overall reputation signal. In alternative embodiments, the architecture may incorporate hybrid rule-learning models, federated training, or other AI frameworks without departing from these teachings.

Referring now to FIG. 12, an integration layer architecture 1200 is illustrated. An OAuth credential vault 1201 stores secure authentication tokens. Payment connectors 1209 and marketplace connectors 1202 integrate external systems. In some embodiments, the integration layer employs zero-knowledge proof protocols to verify ownership of external accounts or credentials without disclosing the external identifiers themselves, thereby enabling cross-platform reputation bootstrapping while preventing user de-anonymization or doxing. Data is received via a webhook or ETL pipeline 1203 and normalized by a transaction normalizer 1204. In alternative embodiments, data ingestion may occur through direct database synchronization, SDK integration, decentralized ledger interoperability, or distributed file storage systems. Standardized records are stored in a cross-platform verification store 1205. A rate limiter and queue manager 1206 manage throughput. Analytics services 1207 capture event metrics, and compliance services 1208 log user consent versions for data governance. In some embodiments, compliance services 1208 also facilitate KYC/AML checks, sanctions screening, and retention/disposition policies. Other credential-exchange mechanisms, including decentralized-identifier (DID) protocols or verifiable-credential frameworks, may also be employed.

Referring now to FIG. 13, a dispute resolution architecture 1300 is illustrated. A dispute triggerer 1301 creates a case in a case manager 1302. Parties are notified through a response portal 1303, and evidence is aggregated 1304. An automated dispute analyzer 1305 attempts resolution. If unresolved, the case is escalated by an escalation router 1306 to a human reviewer. A resolution recorder 1307 logs outcomes into a record store 1308. Policies and configuration 1309 define thresholds. Moderator actions are audited 1310, and support tickets may be generated for user communication.

Referring now to FIG. 14, a deployed system architecture 1400 is illustrated. The platform is accessible through mobile applications 1401 and a web portal 1402. Public profiles 1403 and unique URL gateways 1404 provide external access. An API gateway 1405 manages third-party integrations, routing requests into a services cluster 1406 that executes core platform functions. A centralized database 1407 stores synchronized user and transaction data.

In some embodiments, system-level modules may extend functionality with compliance, monitoring, and analytics. A notification processor 1408 manages delivery of user alerts across email, SMS, and in-app channels. An analytics database 1409 tracks engagement metrics, fraud anomalies, and system performance. A compliance manager 1410 enforces GDPR requests and consent versioning and may orchestrate KYC/AML workflows and consent lineage across integrations. A monitoring and telemetry module 1411 ensures uptime and stability, while an external ecosystem boundary 1412 governs secure interaction with third-party services. Equivalent deployment architectures, including edge computing, multi-tenant SaaS, or on-premises installations, may likewise implement the invention.

Referring now to FIG. 15, a trust-tier and badge-visualization architecture 1500 is shown. A credibility-score input 1501 is received by a score-to-tier mapping module 1506 that consults a threshold table 1502 defining discrete trust levels (e.g., Silver, Gold, Platinum, with each tier corresponding to a range of credibility scores and associated privileges). The badge renderer 1503 generates corresponding visual indicators within a user profile, while a privilege-gate controller 1504 unlocks optional platform features based on tier. A notification service 1505 informs users of tier changes. This architecture converts numerical credibility values into discrete symbolic indicators that communicate trust level across platforms. Other tiering taxonomies or visualization modes may be substituted, including dynamic badges or algorithmically generated trust indicators.

Referring now to FIG. 16, a blind-review reveal and alias-privacy flow 1600 is illustrated. A buyer client 1601 and a seller client 1602 each submit encrypted confirmations through an encryption module 1608 that generates public/private key pairs and encrypts the rating payloads. The encrypted ratings are stored in temporary encrypted storage 1603 until both submissions are complete.

In some embodiments, a temporal-release controller may delay or randomize the publication of confirmed ratings to the public ledger to obscure temporal correlations and further prevent retaliatory behavior in subsequent transactions.

When the second confirmation arrives, a key-exchange trigger 1604 initiates simultaneous decryption so that both ratings are revealed and written together to the ledger 1605, preventing retaliatory bias. An alias-ID resolver 1606 links each encrypted submission to a verified pseudonymous identity established at registration while concealing personal details. A laundering detector 1607 analyzes alias patterns and device fingerprints to detect reputation-laundering behavior.

Together, these elements implement the mutual-reveal mechanism described in FIG. 2, which may in some embodiments be achieved through cryptographic or other coordinated-timing techniques. The process extends the fraud-detection logic of FIG. 11 to privacy-preserving transactions. Alternative encryption or secure-multi-party-computation protocols may perform equivalent simultaneous-reveal and alias-binding operations without departing from the principles of the invention.

Referring now to FIG. 17, a group-based reputation aggregation architecture 1700 is illustrated. Individual users 1704-1706 each maintain verified credibility scores stored in an individual-score database 1707. A group-aggregation module 1701 retrieves these individual scores and applies weighting functions based on each member's trust tier, verified transaction count, and recent audit outcomes. The weighted inputs are combined by a group-score computation engine 1702 to produce a composite group credibility score 1708.

A propagation engine 1703 synchronizes updates between the group score 1708 and the contributing member scores 1704-1706. Positive performance by one member increases the group score proportionally, while group-level degradation feeds back to reduce individual member confidence coefficients. A membership database 1709 maintains group composition, weighting parameters, and temporal participation data, allowing users to belong to multiple groups simultaneously while preserving per-group reputation contexts.

In some embodiments, the group-aggregation module 1701 may also compute a network-level trust index 1710, representing a higher-order aggregation across multiple groups, enabling reputation portability and network-wide ranking. Equivalent implementations may utilize decentralized ledgers, federated scoring nodes, or blockchain-anchored proofs to compute and store group-level reputation values without departing from the principles of the invention.

In this manner, the invention provides a unified platform that integrates user authentication, mutual transaction verification, dispute resolution, credibility scoring, anomaly detection and budgeted audit selection using artificial intelligence, and cross-platform interoperability.

The embodiments described herein are illustrative and not limiting. The foregoing description has been presented to enable those skilled in the art to make and use the invention and to provide the best mode presently contemplated for its practical application. It is not intended to be exhaustive or to limit the invention to the precise forms disclosed, and many modifications and variations will be apparent to those of ordinary skill in the art in light of these teachings. Accordingly, the scope of the invention should be determined by the appended claims and their legal equivalents, rather than by the examples given.

The systems and methods described herein may be implemented on one or more computing devices each comprising at least one processor, system memory, non-transitory storage, and network interfaces. Program modules including the services and engines described (e.g., scoring service, anomaly detection engine) may be executed locally, in the cloud, or in hybrid arrangements. Non-transitory computer-readable media include, without limitation, magnetic storage, optical storage, flash memory, and solid-state drive.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

It should be noted that all features, elements, components, functions, and steps described with respect to any embodiment provided herein are intended to be freely combinable and substitutable with those from any other embodiment, or with the concepts disclosed in the patents or applications incorporated by reference herein. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A method for verifying peer-to-peer transactions through two-way rating confirmation, comprising:
receiving a confirmation from a buyer that a transaction occurred within a predetermined time window;
receiving a confirmation from a seller that the transaction occurred within the predetermined time window;
determining whether both confirmations are received within the predetermined time window; and
enabling submission of credibility ratings and updates to a credibility ledger only upon mutual or implied confirmation, thereby preventing fraudulent reviews.

2. The method of claim 1, wherein failure of one party to provide confirmation within the predetermined time window results in an implied confirmation.

3. The method of claim 1, wherein the buyer and seller confirmations are encrypted and simultaneously revealed upon mutual submission to prevent retaliatory reviews.

4. The method of claim 1, further comprising generating pseudonymous alias identifiers that preserve privacy while enabling accountability of confirmed transactions.

5. A system for adaptive anomaly detection and budgeted audit selection in a peer-to-peer credibility framework, comprising:
an activity log configured to record user transactions and contextual data;
a feature extractor configured to compute behavioral, relational, and content-based features for each transaction;
an anomaly-detection engine configured to generate an anomaly score representing deviation from normative behavior;
a budgeted-audit selector configured to determine an audit probability based on the anomaly score, user trust tier, and reputation estimate according to a budgeted control function; and
a calibration module configured to update parameters of the anomaly-detection engine based on verified audit outcomes, thereby providing continuous-learning feedback that maintains detection accuracy while controlling operational cost.

6. The system of claim 5, wherein the calibration module applies supervised or isotonic mapping to refine the anomaly score.

7. The system of claim 5, wherein the audit probability is computed according to a bounded monotonic control function that increases with anomaly score and decreases with reputation estimate, the function being constrained by minimum and maximum audit rates to maintain verification cost within a predefined budget.

8. The system of claim 5, wherein flagged transactions are quarantined in a suspense state pending verification or moderator review.

9. The system of claim 5, wherein verified audit outcomes are stored as labeled feedback to continuously improve anomaly-detection performance.

10. A method for privacy-preserving two-way rating confirmation, comprising:
encrypting a buyer rating and a seller rating using respective public keys;
storing encrypted ratings in temporary storage until both are received;
initiating a key-exchange trigger upon receipt of a second rating;
simultaneously decrypting both ratings and writing them together to a credibility ledger; and
linking each rating to a verified pseudonymous alias identifier while preventing disclosure of personally identifying information.

11. The method of claim 10, wherein the key-exchange trigger is implemented through asymmetric cryptographic key-pair exchange between clients.

12. The method of claim 10, wherein alias identifiers are periodically regenerated or salted with device-specific entropy to prevent long-term linkage between transactions.

13. The method of claim 10, wherein simultaneous decryption prevents retaliatory bias between counterparties during rating submission.

14. A system for dispute resolution and proof verification in peer-to-peer transactions, comprising:
an evidence-submission interface configured to receive receipts, payment confirmations, photographs, or shipping records;
an optical-character-recognition engine and metadata adapter configured to extract and normalize information from uploaded or linked sources;
a comparator engine configured to evaluate consistency between submitted information and recorded transactions; and
a dispute-resolution module configured to determine an outcome and update credibility scores only after verification of supporting evidence.

15. The system of claim 14, wherein verified transaction records are hashed to a distributed ledger to provide an immutable audit anchor.

16. The system of claim 14, wherein unresolved disputes are submitted to a peer-review arbitration panel composed of verified users whose collective decision is recorded as resolution outcome.

17. A reputation-scoring system for peer-to-peer credibility management, comprising:
a data-ingestion module configured to receive verified transaction data produced by mutually confirmed exchanges and anomaly-calibrated audits;
a scoring engine configured to compute a dynamic credibility score from weighted attributes including timeliness, transaction integrity, and completion reliability;
a normalization module configured to regress inactive scores toward a platform equilibrium value and to apply verification-tier multipliers based on evidence quality; and
a converter configured to translate the credibility score into a display indicator selected from a numerical scale, a letter grade, or a symbolic badge, wherein the score dynamically reflects verified activity and model feedback, thereby improving technical integrity of reputation data compared with unverified or subjective rating systems.

18. The system of claim 17, wherein the credibility score incorporates risk-adjusted weighting factors, score-decay functions, and normalization toward a global equilibrium to maintain temporal stability.

19. The system of claim 17, wherein separate buyer and seller scores are maintained and aggregated into an overall composite credibility index.

20. The system of claim 17, wherein confidence coefficients representing statistical reliability of the credibility score are computed and displayed with each indicator.

21. The system of claim 17, further comprising a group-aggregation module configured to compute a group-level credibility score from individual scores of multiple verified members, wherein each member's contribution is weighted according to their credibility tier, transaction reliability, or participation history, and wherein changes to individual scores dynamically influence the group score and vice versa.

22. A non-transitory computer-readable medium storing instructions that, when executed by one or more processors, cause a system to perform operations comprising:
verifying peer-to-peer transactions through two-way rating confirmation;
receiving and verifying transaction proof in disputed cases;
computing calibrated anomaly scores and selecting audits according to a budgeted control function;
generating and updating credibility scores based on verified activity and dynamic weighting;
integrating with third-party payment platforms and marketplaces; and
distributing credibility indicators and tier data across mobile and web applications through a unified backend service.

23. The non-transitory computer-readable medium of claim 22, wherein the instructions further cause synchronization of data across devices and assignment of unique public URLs for user-profile access.

24. The non-transitory computer-readable medium of claim 22, wherein the instructions further cause the system to link external accounts, normalize imported transaction data, and store verified outcomes and fraud flags within a unified database.

25. The non-transitory computer-readable medium of claim 22, wherein the instructions further cause the system to enforce user-privacy, consent, and data-retention policies consistent with applicable compliance requirements.

26. The non-transitory computer-readable medium of claim 22, wherein the instructions further cause the system to compute and render confidence coefficients representing statistical reliability of displayed credibility scores.

27. The non-transitory computer-readable medium of claim 22, wherein ownership of external accounts or credentials is verified using a zero-knowledge proof protocol that establishes account linkage without revealing external account identifiers.
